(19) United States
(12) Patent Application Publication
(10) Pub. No.: US 2007/0135031 A1
(43) Pub. Date: Jun. 14, 2007

(54) Exhaust assembly with grease collector

(76) Inventor: Nicholas Vlamis, Trumbull, CT (US)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/602,541

(22) Filed: Nov. 21, 2006

Related U.S. Application Data
(60) Provisional application No. 60/739,366, filed on Nov. 23, 2005.

(51) Int. Cl. B08B 15/02

(52) U.S. Cl. 454/67

(57) ABSTRACT

An exhaust assembly comprising an exhaust fan, and a grease containment and collection system. The exhaust fan is oriented at an angle relative to the roof or mounting surface resulting in improved grease containment and collection. Additionally, the open end of the exhaust fan is shielded from rain, snow and other elements as a result of the angled orientation. A system where the grease and water condensate that forms on the inside of an exhaust fan are separately contained and collected.

### CROSS-REFERENCE TO RELATED APPLICATIONS

This application claims the priority of U.S. Provisional Application No. 60/739,366, filed on Nov. 23, 2005.

### BACKGROUND OF THE DISCLOSURE

1. Field of the Disclosure

This disclosure relates generally to a roof top exhaust assembly. More particularly, the present disclosure relates to an exhaust assembly with a grease containment and collection system.

2. Description of Related Art

Restaurants, especially fast food establishments, produce high volumes of grease that are typically discharged or vented through a roof-mounted exhaust system. The grease that is discharged or vented may accumulate on both the exhaust system and the roof and cause deterioration of the exhaust system and roof, adversely effect the exhaust system performance, and/or pose extreme fire hazards. As a result, frequent cleaning and maintenance of the exhaust system and/or roof is required, which is messy and time consuming.

To compound the problem of grease accumulation on the exhaust system and roof, both are exposed to the outside elements, notably, rain and/or snow. As a result, cleaning and maintenance can be further complicated, since the rain and/or snow may also collect in or around the exhaust system.

Current assemblies that attempt to contain and/or collect the grease in exhaust systems are generally inefficient. In many of these systems, grease leaks through the assembly and saturates the roof, creating a hazardous and unsanitary condition. In addition, most of these assemblies do not address the complications associated with the outdoor elements.

Therefore, there is a need for improvements on currently available grease collection and containment systems, which will prevent the grease from collecting and fouling the exhaust system and from saturating and deteriorating the roof. An additional need exists to mitigate the additional problems associated with weather elements on the operation of the exhaust systems.

### SUMMARY OF THE DISCLOSURE

The present disclosure provides an exhaust assembly comprising an exhaust fan connected to a mounting surface, and a collector. The exhaust fan is angled relative to the mounting surface, so that grease and/or water in the exhaust assembly is collected in the collector. The exhaust fan can comprise an exhaust portion and a base portion, wherein the base portion is connected to the mounting surface. The exhaust fan can be disposed at an angle of between about 5° to about 50°, relative to the mounting surface. More preferably, the exhaust fan is disposed at an angle of between about 10° to about 30°, relative to the mounting surface, and most preferably, the exhaust fan is disposed at an angle of about 18°, relative to the mounting surface.

The exhaust assembly can further comprise a conduit disposed between the exhaust fan and the collector. The collector can also be portable. The exhaust assembly can further comprise a grease extractor connected to the collector, so that grease collected therein is extracted from the collector. The exhaust assembly can also further comprise a degreaser, which removes at least a portion of grease disposed about an exhaust end of the exhaust fan.

In another embodiment of the exhaust assembly of the present disclosure, the assembly can comprise an exhaust fan connected to a mounting surface, a grease collector, and a water collector, where the exhaust fan is angled relative to the mounting surface. Grease in the exhaust assembly is substantially collected in the grease collector, and water in the exhaust assembly is substantially collected in the water collector. The exhaust fan can comprise an exhaust portion and a base portion, wherein the base portion is connected to the mounting surface. The exhaust fan can be disposed at an angle of between about 5° to about 50°, relative to the mounting surface. More preferably, the exhaust fan is disposed at an angle of between about 10° to about 30°, relative to the mounting surface, and most preferably, the exhaust fan is disposed at an angle of about 18°, relative to the mounting surface.

The exhaust assembly can further comprise a conduit disposed between the exhaust fan and the grease collector, and a second conduit disposed between the exhaust fan and the water collector. The exhaust assembly can further comprise a degreaser system to clean an exhaust end of the exhaust fan.

In a third embodiment of the exhaust assembly of the present disclosure, the exhaust assembly can comprise an exhaust fan connected to a mounting surface, a grease condensation area, a water condensation area, a first conduit connected to the grease condensation area, and a second conduit connected to the water condensation area. The exhaust fan can be disposed at an angle of between about 5° to about 50°, relative to the mounting surface. More preferably, the exhaust fan is disposed at an angle of between about 10° to about 30°, relative to the mounting surface, and most preferably, the exhaust fan is disposed at an angle of about 18°, relative to the mounting surface. The exhaust assembly can further comprise a grease extractor connected to the first conduit and the second conduit, whereby water and/or grease collected therein is extracted from the first conduit and the second conduit.

### BRIEF DESCRIPTION OF THE DRAWINGS

FIG. 1 is a side view of a first embodiment of the exhaust assembly of the present disclosure;

FIG. 2 is a side view of a second embodiment of the exhaust assembly of the present disclosure;

FIG. 3 is a side view of a third embodiment of the exhaust assembly of the present disclosure;

FIG. 4 is a side view of a fourth embodiment of the exhaust assembly of the present disclosure; and

FIG. 5 is a side view of a fifth embodiment of the exhaust assembly of the present disclosure.

### DETAILED DESCRIPTION OF THE EMBODIMENTS

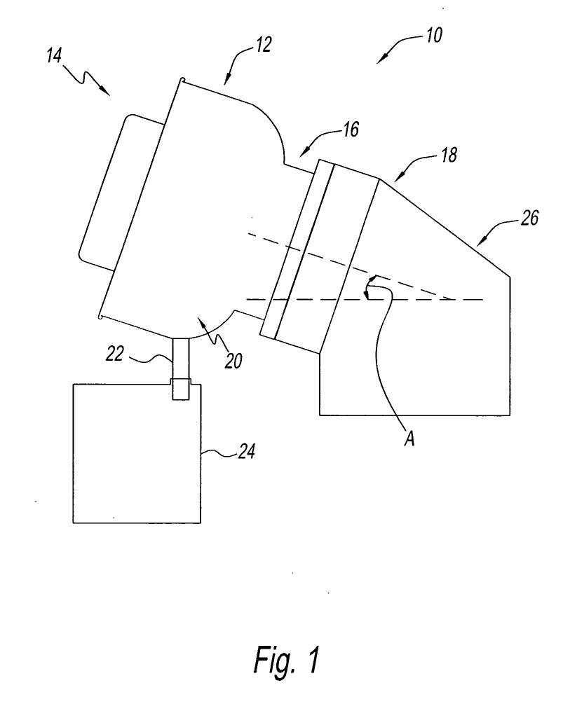

Referring to FIG. 1, an exhaust assembly with a grease containment and collection system in accordance with the present disclosure is shown, and referred to by numeral 10. The exhaust assembly 10 includes exhaust fan 12. Exhaust fan 12 has an open or exhaust end 14 and a base end 16. Base end 16 is typically mounted to a base 18, which in turn sits on, or protrudes from, a roof or similar surface of a building (not shown).

Kitchen exhaust typically contains grease and water vapor. As the kitchen exhaust is vented up through the exhaust fan 12, the grease and water condenses on the inner surfaces (not shown) of the exhaust fan. To address this, an important aspect of the present disclosure provides that exhaust fan 12 is angled or pitched. As a result of the pitch of exhaust fan 12, gravitational forces cause the flow of the condensed grease and water into to collection area 20.

It should be understood that the exhaust fan 12 may be pitched at any angle that results in the gravitational flow of grease condensate to the desired collection area 20. In a preferred embodiment, it has been found that the exhaust fan 12 should be pitched at an angle A between about 5° to about 50°, relative to a roof and/or mounting surface. More preferably, angle A is between about 10° to about 30°, and most preferably, angle A is about 18°.

Any means may be used to provide a pitched or angled exhaust fan 12. As exemplified in FIG. 1, the base 18 has an angled portion 26, which corresponds to the desired angle to be imparted to the exhaust fan 12, when exhaust fan 12 is mounted to base 18. By angling base 18, it allows a user to employ an existing or standard commercially available exhaust fan, since no modification to the exhaust fan is required to achieve the desired angle or pitch.

Preferably, exhaust fan 12 includes a grease withdrawal mechanism that allows the grease to flow out of collection area 20 and into a further containment or collection device. As shown by way of example in FIG. 1, exhaust fan 12 is fitted with a conduit 22, such as a drain pipe, which discharges into container 24. The grease that flows into container 24 can then be disposed of.

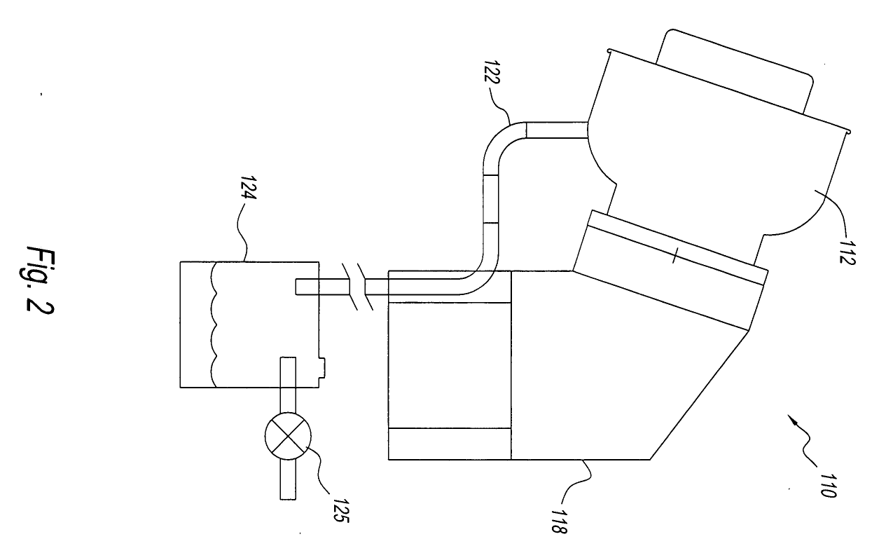

Referring to FIG. 2, a second embodiment of the present disclosure is shown, and referred to by numeral 110. Exhaust assembly 110 is virtually identical to exhaust assembly 10 of FIG. 1, with the exception that instead of a portable container, the waste product removed from the exhaust fan 112 flows through a conduit 122. Conduit 122 can run under exhaust fan 112 and into base 118. Conduit 122 can then terminate in container 124, which can be disposed within the building. Container 124 has a grease extractor 125 connected thereto, which creates a vacuum pressure within container 124 and conduit 122, that facilitates the drainage of the grease from fan 112. In the shown embodiment, the grease extractor 125 is a fan that creates a vacuum pressure within conduit 122, but the present disclosure further contemplates the use of any suitable grease withdrawal mechanism and/or containment means.

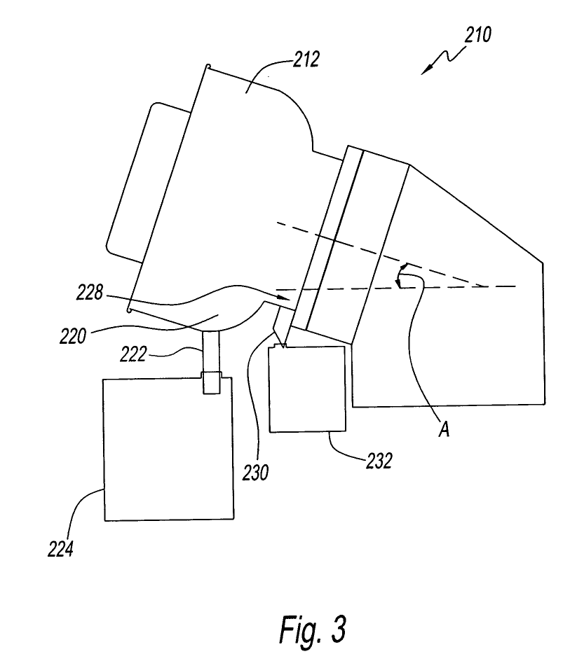

Now referring to FIG. 3, a third embodiment of the exhaust assembly is shown, and referred to by numeral 210. Exhaust assembly 210 is similar to exhaust assemblies 10 and 110 of the previous embodiments, with the exceptions outlined below. Exhaust assembly 210 has exhaust fan 212, grease condensation area 220, and water condensation area 228. It has been surprisingly found that as a result of the pitched exhaust fan 212, substantial amounts of the grease and water condense at different locations within the exhaust fan 212, allowing for the substantial separation of water from the grease. Condensed water, for example, can collect substantially in water condensation area 228, where grease can collect substantially in grease condensation area 220. This further simplifies the maintenance of the exhaust assembly 210 and disposal of the grease and water from the assembly.

Exhaust fan 212 can include a water withdrawal mechanism that allows the condensed water to flow out of water collection area 228 and into a further containment or collection device. In the shown embodiment, the water withdrawal mechanism is a conduit 230 that drains into container 232. Thus, in addition to conduit 222 and container 224, which collect grease from fan 212, exhaust assembly 210 further has conduit 230 and container 232 to collect the water. Again, it should be understood that any suitable grease withdrawal mechanism and/or containment means may be employed in the exhaust assembly of the present disclosure.

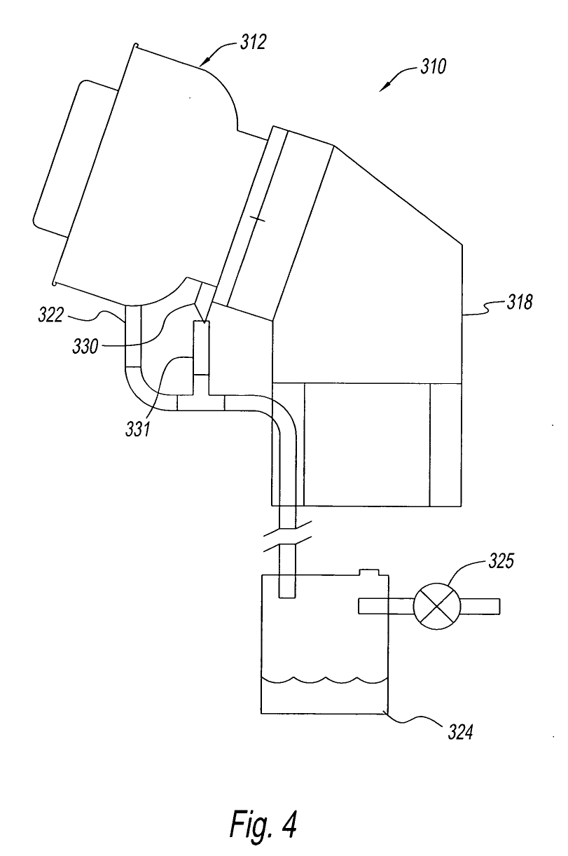

Referring to FIG. 4, a fourth embodiment of the exhaust assembly of the present disclosure is shown, and referred to by numeral 310. Exhaust assembly 310 is similar to the exhaust assemblies of the previous embodiments, with the differences discussed in further detail below.

Exhaust assembly 310 has exhaust fan 312. Conduit 322 and spout 330 are operably connected to exhaust fan 312, so that grease and water are drained from exhaust fan 312, in the manner discussed above. Spout 330 is operably connected to connector pipe 331, which is operably connected to conduit 322. Similarly to conduit 122 of exhaust assembly 110, conduit 322 can run under exhaust fan 312, and into base 318 of exhaust assembly 310. Conduit 322 can then empty into container 324. Grease extractor 325 is connected to container 324, so that a vacuum pressure is exerted within conduit 322. The grease and water mixture within container 324 can then be disposed of.

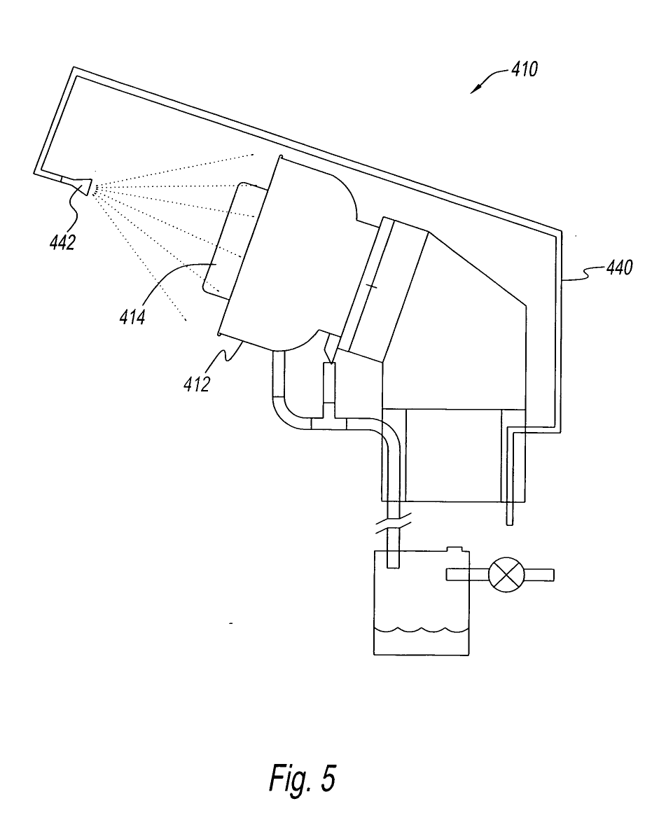

Referring to FIG. 5, a fifth embodiment of the present disclosure is shown, and referred to by reference numeral 410. Exhaust assembly 410 can have a degreaser system that comprises a feed pipe 440 and a nozzle 442. In this embodiment, a degreasing solution can be supplied to feed pipe 440, where it is sprayed onto the exhaust end 414 of the exhaust fan 412 through nozzle 442. The degreaser solution supplied in this manner can thus clean off the exhaust end 414 of exhaust fan 412. The degreaser system can be programmed so that the solution is supplied at regular intervals, or the solution can be supplied manually. Such methods are well known to those in the art. The degreaser used can be any of several readily available commercial products, such as Simple Green. The degreaser system can be used with any of the above-described embodiments of the exhaust assembly of the present disclosure.

In addition to the above-noted unexpected results of the present disclosure, it has also been observed that the angled or pitched exhaust fans of the present disclosure effectively reduce the exposure of the exhaust ends of the exhaust fans to weather related elements, such as, for example, rain and snow. By reducing and/or eliminating rain and snow from entering the exhaust fans, it eliminates or mitigates the need to remove rainwater and melted snow from the interior of the exhaust fan. Additionally, it mitigates the build-up of snow and ice in the exhaust fan, thus preventing blockage and malfunction of the exhaust fans.

From the foregoing and as mentioned above, it is observed that numerous variations and modifications may be effected without departing from the scope and spirit of the present disclosure. It is to be understood that no limitation with respect to the specific apparatus illustrated herein is intended or should be inferred.

What is claimed is:

1. An exhaust assembly comprising:
an exhaust fan connected to a mounting surface; and
a collector,
wherein said exhaust fan is angled relative to said mounting surface, whereby grease and/or water in said exhaust assembly is collected in said collector.

2. The exhaust assembly of claim 1, wherein said exhaust fan comprises an exhaust portion and a base portion, wherein said base portion is connected to said mounting surface.

3. The exhaust assembly of claim 1, wherein said exhaust fan is disposed at an angle of between about 5° to about 50°, relative to said mounting surface.

4. The exhaust assembly of claim 3, wherein said exhaust fan is disposed at an angle of between about 10° to about 30°, relative to said mounting surface.

5. The exhaust assembly of claim 4, wherein said exhaust fan is disposed at an angle of about 18°, relative to said mounting surface.

6. The exhaust assembly of claim 1, further comprising a conduit disposed between said exhaust fan and said collector.

7. The exhaust assembly of claim 1, wherein said collector is portable.

8. The exhaust assembly of claim 1, further comprising a grease extractor connected to said collector, whereby grease collected therein is extracted from said collector.

9. The exhaust assembly of claim 1, further comprising a degreaser, which removes at least a portion of grease disposed about an exhaust end of said exhaust fan.

10. An exhaust assembly comprising:
an exhaust fan connected to a mounting surface;
a grease collector; and
a water collector,
wherein said exhaust fan is angled relative to said mounting surface, and
whereby grease in said exhaust assembly is substantially collected in said grease collector, and water in said exhaust assembly is substantially collected in said water collector.

11. The exhaust assembly of claim 10, wherein said exhaust fan comprises an exhaust portion and a base portion, wherein said base portion is connected to said mounting surface.

12. The exhaust assembly of claim 10, wherein said exhaust fan is disposed at an angle of between about 5° to about 50°, relative to said mounting surface.

13. The exhaust assembly of claim 10, wherein said exhaust fan is disposed at an angle of between about 10° to about 30°, relative to said mounting surface.

14. The exhaust assembly of claim 10, wherein said exhaust fan is disposed at an angle of about 18°, relative to said mounting surface.

15. The exhaust assembly of claim 10, further comprising a conduit disposed between said exhaust fan and said grease collector.

16. The exhaust assembly of claim 15, further comprising a second conduit disposed between said exhaust fan and said water collector.

17. The exhaust assembly of claim 11, further comprising a degreaser system to clean an exhaust end of said exhaust fan.

18. An exhaust assembly comprising:
an exhaust fan connected to a mounting surface;
a grease condensation area;
a water condensation area;
a first conduit connected to said grease condensation area; and
a second conduit connected to said water condensation area,
wherein said exhaust fan is angled relative to said mounting surface.

19. The exhaust assembly of claim 18, wherein said exhaust fan is disposed at an angle of about 18°, relative to said mounting surface.

20. The exhaust assembly of claim 1, further comprising a grease extractor connected to said first conduit and said second conduit, whereby water and/or grease collected therein is extracted from said first conduit and said second conduit.
